(19) United States
(12) Patent Application Publication
(10) Pub. No.: US 2005/0070247 A1
(43) Pub. Date: Mar. 31, 2005

(54) Emergency notification system using presence, triangulation, and wireless telephony

(76) Inventors: Keith N. Larson, Malvern, PA (US); Ronald Roehrig, Tinton Falls, NJ (US); James L. Murtaugh, Holdmdel, NJ (US)

Correspondence Address: Richard C. Woodbridge;Synnestvedt Lechner & Woodbridge LLP, P.O. Box 592, Princeton, NJ, 08542, US

(21) Appl. No.: 10/674,515

(22) Filed: Sep. 30, 2003

(51) Int. Cl. H04M 11/04

(52) U.S. Cl. 455/404.1

(57) ABSTRACT

A system and method for providing alert messages to users of Mobile Subscriber Units whereby only such users who are located in the local geographical area effected by the alert receive the messages. The invention further permits limiting transmission of such alerts to only appropriate categories of message content (e.g. weather only) and classification of recipients (e.g., volunteer firemen).

### FIELD OF THE INVENTION

The present invention relates to the use of wireless telephony to identify the specific location of a user and thereby provide location-specific emergency notification to him.

### BACKGROUND OF THE INVENTION

The science of meteorology has continued to advance rapidly allowing increasingly accurate detection and prediction of severe and hazardous weather conditions. Specifically, Doppler radar systems and high resolution satellites allow early detection of weather events such as tornadoes and severe thunderstorms and permit accurate tracking of their paths.

The National Weather Service and National Oceanographic and Atmospheric Administration now routinely issue warnings in advance of such severe weather events. To be effective, these warnings need to be communicated to individuals who are potentially in harm's way. As discussed in U.S. Pat. No. 6,329,904 issued Dec. 11, 2003 to George Lamb, and hereby incorporated by reference, cellular and PCS telephone networks are capable of being used to transmit more localized emergency alert messages.

While U.S. Pat. No. 6,329,904 permits receipt of emergency alerts to cell phones or wireless devices in a more localized area, increased effectiveness of the alerts could be realized with an alert communication directed to a recipient whose exact location is known relative to the emergency event. That is, the present invention provides warnings and/or specific instructions based on triangulated or GPS based information which exactly pinpoints the location of the recipient. Such a system has significant advantages over the prior art. For instance with a localized storm, such as a tornado, prior art methods broadcast the same information to all parties in the general area. Since most severe storms are extremely localized, the proper course of action will be different depending on the relative position of the person receiving the information. For example, traffic to the south of the storm should either move south or stop, those to the north should move north or stop, etc.

The present invention which utilizes the location of the user, and directs the content of the message with that location in mind, attains multiple advantages over the prior art. By way of additional example, not only does this enable specific information to be transmitted which relates to the status or location of a localized storm, but additional useful information can be supplied such as given specific instructions to guide the user to a shelter. Such information is particularly useful for interstate travelers, unfamiliar with local roads, who may encounter severe weather conditions or adverse road conditions.

### SUMMARY OF THE INVENTION

The present invention uses wireless telephony to direct relevant messages to users located in a specific area. Such a system might be employed as a service to the subscriber of a cell phone provider. This system relies on automatically determining the location of the user and delivering a message which is specific to that location.

While much of the discussion of this invention is directed to warnings relating to approaching storms, the invention is not so limited. For example, the system could be used to warn motorists of road blockages due to accidents, floods, avalanches, and rock slides. Another possible use is Amber Alert Systems that are being implementing in more and more States. This concept could also be applied to wireless business phone systems where a localized area in a large building could be notified of a problem without alerting other areas of the building. This could also be used to direct emergency responses. Both as a locator of victims and to guide emergency personnel to the site or a specific area of a building located on that site. By way of example, volunteer firemen frequently cannot respond quickly enough to get to the station and meet the fire truck at the location of the fire. Instead of clogging up the radio waves with requests for directions to the emergency, their cell phone could provide specific instructions for them to get to the emergency.

The present invention relays messages of relevance to individuals who are situated in a particular geographical area. Accordingly, the invention comprises determining the exact locations of those individuals. With that knowledge, the system has the ability to provide specific instructions which will allow a recipient to get information on a recommended course of action for him. In the example of a motorist, this could be to stop, turn around, or go to a shelter.

### BRIEF DESCRIPTION OF THE DRAWINGS

Various embodiments of the present invention will now be described in detail in conjunction with the annexed drawings, in which:

FIG. 1 is a pictorial representation of an exemplary alert broadcast system in accordance with an embodiment of the present invention.

### DETAILED DESCRIPTION

The present invention enables users of wireless communication devices to receive automatic notification of an emergency situation that exists at their present location. Accordingly, an important aspect of the present invention is the automatic determination of the user's geographical position. There are various well-known prior art methods for so locating a user. For instance, there are two widely accepted and commercially available methods of determining the position of a cellular phone. One is a network based system that relies on angle of arrival (AOA) and time of arrival (TOA) of the radio signals from the handset. The second is a GPS based system where a handset is located by the GPS satellite network. A location server system, marketed by Qualcomm, Incorporated of San Diego Calif., under the name of gpsOne, in fact utilizes both methods in their system to improve on the system's performance. While such accurate methods are present in a preferred embodiment of the invention, alternative embodiments do not require such precision. By way of example, alternative embodiments rely on the cell phone system to provide the location of the user. That is, and as is well known in the prior art, the FCC requires network providers to have the capability of locating 95% of the cell phones to within 150 meters (and 67% of cell phones to within 50 meters).

Once the user's positions is determined, the invention automatically provides him with emergency alert messages should they effect him. Prior art notifications of such emergency situations are generated by agencies such as the National Weather Service Tornado Tracking System, the Amber Alert System, and local emergency management command centers. With the present invention, the information provided by these agencies would be supplied to the wireless network. Various means for such a communication interface are well known in the art to include, internet or permanent connections such as frame relay connections.

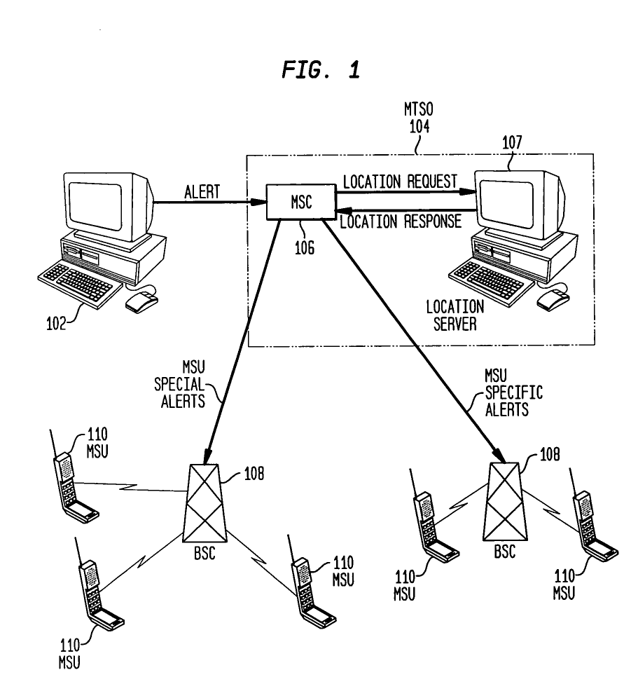

FIG. 1 illustrates the architecture of one embodiment of the present invention. FIG. 1 depicts the functional components of a conventional wireless communication system. In particular, there is a Mobile Telephone Switching Office (MTSO) 104, and contained therein, at least one Mobile Switching Center 106 (MSC). The MSC is responsible for administering cell phone communications to various Mobile Subscriber Units 110 (MSU) that are in its functional area. Accordingly, the MSC recognizes all MSU's that are turned on that are located in a cell area serviced by the MSC. Each of these cell areas are served by a Base Station Controller 108 (BSC). Cell phone communications are actually established through transmissions over the appropriate BSC 108.

In the embodiment of the invention depicted in FIG. 1, an alert is generated by expert software at the National Weather Service 102. This information is supplied to the appropriate MSC 106. Alternative embodiments would receive similar information from various other agencies that report an emergency alert message and the geographical area effected by the alert situation.

In the embodiment depicted in FIG. 1, once the alert is received at the MSC, it determines the cell areas effected by the alert. Contained within the MSC is a location server 107 that will locate the position of all active MSU's. Such servers are well-known, commercially available location servers that will locate a particular MSU. All MSU's in an area effected by the alert are then automatically supplied information relating to the alert. The information actually received by the MSU can be in various forms to include various combinations of display devices, audio alerts and actual voice messages.

As noted above, an important feature of the present invention is that notification is performed automatically to each user in the cell phone network who is determined to be located in the effected area of the alert. In additional embodiments of the invention it is contemplated that the user be permitted to enter commands (e.g., via the MSU keypad or verbally) to set a parameter in his user profile whereby the user can customize any notifications to him. This user profile is part of a data base that is maintained by the cell phone service provider and that is readily accessible by the MSC.

The customization of the content of the transmitted notifications may include e.g., limiting the notifications to only weather alerts, requesting all alerts except traffic conditions, requesting updates occur not more frequently than every 5 minutes, or disabling the notification feature entirely. Thus, not only would the invention determine what users are in the effected area but what status of notification they desire before any alert signal is directed to them by the BSC.

Further, additional embodiments of the invention contemplate designations within a user's profile for various categories of users. Thus, a user established as a volunteer fireman would receive alerts relating to messages sent by the local government agency intended for fireman. Thus MSU's in the area who are not firemen would not receive unwanted alerts about a current local fire. Of course, such non-fireman would receive alerts if such a fire effected traffic and the system is enabled them to receive traffic alerts.

In additional embodiments of the invention, the messages delivered to the MSU can provide directions as to how to proceed to a location (e.g., the scene of an accident, the scene of a fire, the location of a shelter, etc.). Such directions require that both the destination and the present location of the MSU user be determined. Various ways of defining these destinations are well known in the art. These can frequently be done automatically as in establishing the place of origin of a 911 call or the location of an activated automatic fire alarm. Where such automatic procedures are not applicable (e.g., storm shelters), the destinations must be entered into a data base. It is anticipated that such a data base would be maintained at the MSC. The MSC would also contain computer programs to implement various algorithms which for example, would determine the closest shelter to a user's current position, advise him what action to take in response to the Tornado alert in his area (e.g., “continue driving south”, “seek shelter”, etc.), or provide him with directions to the destination. Actual directions from the current MSU location to the defined destination can be readily provided by well-known prior art methods such as MAPQUEST.

It will be understood that the forgoing description of the invention is by way of example only, and variations will be evident to those skilled in the art without departing from the scope of the invention, which is as set out in the appended claims.

1. A method for a cell phone service provider to communicate to a cell phone user, said user located in a particular local geographical area, an alert message that effects that particular local geographical area, said method comprising the steps of:
determining the user is located in said geographical area;
receiving said alert message from a reporting agency, said message containing information as to locations effected;
determining cellular phone cells that are serviced by the cell phone service provider and that are in the effected locations; and,
providing to the user at least one communication advising him of the alert message.

2. The method of claim 1 wherein the reporting agency is selected from the group consisting of National Weather Service, National Oceanographic and Atmospheric Administration, Amber Alert Systems, State Police, and local police.

3. The method of claim 1 wherein said communication is selected from the group consisting of displaying information, triggering an audio alert, and supplying a voice message.

4. The method of claim 1 further comprising the step of:
permitting the user to limit said providing step based upon subject content of the message.

5. The method of claim 1 further comprising the step of:
permitting the user to limit the frequency at which said communications are provided to him.

6. The method of claim I further comprising the step of:
limiting said providing step to only those users who are members of a certain class of recipients intended to receive said alert message.

7. The method of claim 1 further comprising the steps of:
defining the location of a destination contained in the message; and,
communicating to the user directions from his present location to said destination.

8. A system for communicating from a cell phone service provider to a cell phone user, said user located in a particular local geographical area, an alert message that effects that particular local geographical area, said system comprising:
a first determining means for determining the user is located in said geographical area;
means for receiving said alert message from a reporting agency, said message containing information as to locations effected;
a second determining means for determining cellular phone cells that are serviced by the cell phone service provider and that are in the effected locations; and,
means for providing to the user at least one communication advising him of the alert message.

9. The system of claim 8 wherein the reporting agency is selected from the group consisting of National Weather Service, National Oceanographic and Atmospheric Administration, Amber Alert Systems, State Police, and local police.

10. The system of claim 8 wherein said communication is selected from the group consisting of displaying information, triggering an audio alert, and supplying a voice message.

11. The system of claim 8 further comprising:
means for permitting the user to limit said providing means based upon subject content of the message.

12. The system of claim 8 further comprising:
means for permitting the user to limit the frequency at which said communications are provided to him.

13. The system of claim 8 further comprising:
means for limiting said providing means such that said at least one communication is provided to the user only if he is a member of a certain class of recipients intended to receive said alert message.

14. The system of claim 8 further comprising:
means for defining the location of a destination contained in the message; and,
means for communicating to the user directions from his present location to said destination.
